(19) United States
(12) Patent Application Publication
(10) Pub. No.: US 2003/0228881 A1
(43) Pub. Date: Dec. 11, 2003

(54) Mobile terminal device

(75) Inventors: Shinya Yamamoto, Hitachinaka (JP); Takeshi Hoshino, Kodaira (JP); Reiko Inoue, Komaeshi (JP); Susumu Kojima, Hitachinaka (JP)

Correspondence Address: Townsend and Townsend and Crew LLP, 8th Floor, Two Embarcadero Center, San Francisco, CA, 94111, US

(73) Assignee: HITACHI, LTD., Tokyo (JP)

(21) Appl. No.: 10/388,768

(22) Filed: Mar. 13, 2003

(30) Foreign Application Priority Data
Mar. 15, 2002 (JP) 2002-071212

(51) Int. Cl. H04M 1/00

(52) U.S. Cl. 455/550.1; 455/566; 455/567

(57) ABSTRACT

A mobile terminal device, comprising: a pointing unit which generates outputs associated with a pressing position and a pressing force on a pressing surface; a control unit which controls various functions by using the outputs coming from the pointing unit; a display unit which is controlled by the control unit; and an announcer which includes a plurality of announcement methods. The control unit controls the announcer to select at least one of a plurality of announcement methods based on the pressing force exerted on the pointing unit.

### CROSS-REFERENCES TO RELATED APPLICATIONS

The present application claims priority from Japanese Patent Application No. 2002-071212, filed on Mar. 15, 2002.

### BACKGROUND OF THE INVENTION

The present invention relates to a mobile terminal device provided with a pointing device which generates outputs associated with a pressing position and a pressing force on a pressing surface, and more specifically to a mobile terminal device having an announcing device suitable for announcing inputs made on the pointing device.

A mouse used in a personal computer is a typical example of a pointing device used for inputting a location in a X-Y direction on a display screen. The mouse is a device which designates a location by detecting movements along the X-axis and Y-axis directions based on the rotational degree of a track ball built in the mouse, and then by pressing a switch having a binary ON-OFF switch. A user can choose a time to designate a point by the motion of clicking the switch.

Japanese Patent Laid-open No. 2001-56746 is an example of a mouse-type pointing device using a pressure sensor instead of a track ball. With the device disclosed in the patent, pressure sensors are disposed as a unit to operate the pointing device on the upper part of a mouse, thereby moving the display area on a virtual screen according to the pressure provided on these sensors.

### BRIEF SUMMARY OF THE INVENTION

A pointing device using a track ball tends to be large. When it is designed to be suitable for manipulation, the entire size or thickness increases, thus making the device unsuitable for mobile terminal devices for which miniaturization and low-profile design are mandatory, particularly mobile phones or personal digital assistants (“PDAs”), or other portable electronic devices.

In addition, because the device disclosed in Japanese Patent Laid-open No.2001-56746, is designed so that a display area is moved on a virtual screen in accordance with the level of pressure or pressing force applied on a pressure sensor, it is necessary to provide another entry key to determine the direction of movement or to otherwise provide a pressure sensor for each of up, down, right and left directions. Consequently, the device raises the problems that the number of entry keys increase when it is employed with a mobile terminal device, thus increasing the device in size, and that the number of times entry keys are used increase movement of a pointer or a screen, thus degrading the operability of the device.

A pointing device capable of entering a 360° pointing function with respect to an image displayed on the display unit is needed for mobile terminal devices, etc., and the development of such devices is underway. An example of a mobile terminal device including a pointing device that can be used for such applications is disclosed in Japanese Patent Application No. 2002-55244 by the inventor(s) of the present invention.

However, a pointing device having these new functions may be difficult for a user to recognize that an executed entry has been detected (i.e., that outputs from the pointing device have been captured by a control unit) since responses to the pressing force are insufficient, whereas the device has the advantage that the pointing operation can be entered in all directions.

One embodiment is directed to a manipulation announcing device enabling a user to be aware of an announcement of the detection of entries made by a pointing device that is capable of entering the level of pointing operation in any directions.

In one embodiment of the present invention, a mobile terminal device has a pointing unit which generates outputs associated with a pressing position and a pressing force on a pressing surface, a control unit which controls various functions by using outputs from the pointing unit, a display unit controlled by the control unit, and an announcer which includes a plurality of announcement methods. The control unit controls the announcer to select at least one of a plurality of announcement methods based on the pressing force exerted on the pointing unit.

### BRIEF DESCRIPTION OF THE DRAWINGS

FIG. 1 is a block diagram showing the configuration of a mobile terminal device implemented by an embodiment of the present invention.

FIG. 2 is a perspective diagram showing the external appearance of the mobile terminal device of an embodiment of the present invention.

FIG. 3 is a diagram showing directions of pressing a pointing unit of a mobile terminal device according to the present invention.

FIG. 4 is a characteristic diagram showing the relationship between pressing force and an output of the pointing unit of a mobile terminal device according to the present invention.

FIG. 5 is a diagram showing a configuration of the pointing unit of a mobile terminal device in the embodiment of the present invention, wherein diagram (A) is a block diagram of the pointing unit, diagram (B) is a section view of a structure of the pointing unit, and diagram (C) is a section view of an example where a pressing surface is pressed.

FIG. 6 is a diagram showing the relationship between the pressing forces and control signals of a pointing unit of a mobile terminal device in an embodiment of the present invention.

FIG. 7 is a diagram showing a control signal which controls output patterns of an announcing means for output to driving circuit unit 80 from CPU 30 of a mobile terminal device in an embodiment of the present invention.

FIG. 8 is a diagram showing an example of the display unit when a pressing force is applied to the pointing unit of a mobile terminal device in an embodiment of the present invention.

FIG. 9 is a diagram showing another example of the display unit when a pressing force is applied to the pointing unit of a mobile terminal device in an embodiment of the present invention.

FIG. 10 is a diagram showing an example of pointer movement when a pressing force is applied to a pointing unit of a mobile terminal device in an embodiment of the present invention.

FIG. 11 is a diagram showing an example of pointer movement when a pressing force is applied to the pointing unit of a mobile terminal device in an embodiment of the present invention.

FIG. 12 is a perspective diagram of showing a state where a mobile terminal device in an embodiment of the present invention is held by hand.

### DETAILED DESCRIPTION OF THE INVENTION

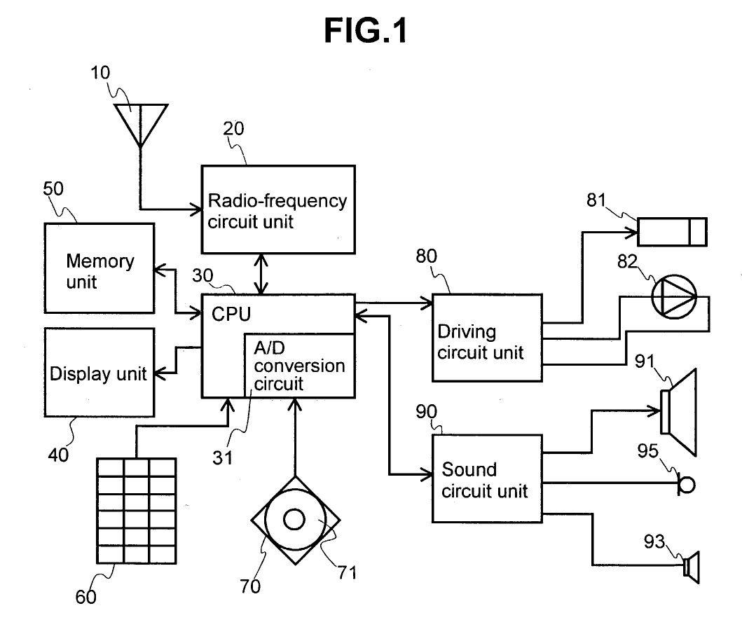

Hereinafter, an embodiment of the present invention is described with reference to FIGS. 1 to 8. In the present embodiment, a mobile terminal device used as a manipulation announcing device is described. However, the present embodiment is not limited to a mobile terminal device, and may be applied to other electronic equipment.

FIG. 1 shows an overall configuration of a mobile terminal device according to the present embodiment. As shown in FIG. 1, the device comprises an antenna 10; a radio-frequency circuit unit 20 connected to the antenna 10; and a CPU 30 as control means for various functions, the CPU being coupled to a display unit 40, a memory unit 50, a key entry unit 60, a pointing unit 70 (also referred to as, “selector,” “pointer,” “input device”), a driving circuit unit 80, and a sound circuit unit 90. Pointing unit 70 outputs are triggered by manipulation by a user, a voltage signal of the X-axis and the Y-axis relating to the pressing force and pressing position of such manipulation. CPU 30 has an A/D conversion circuit 31 and can read voltage signals from pointing unit 70. Further, CPU 30 controls relevant units in accordance with a control program stored in memory unit 50. Driving circuit unit 80 is connected to a vibration-generating unit 81 and a light-emitting unit 82, and manages the operating amount and operating pattern of vibration-generating unit 81 and light-emitting unit 82 based on control by CPU 30. In addition, sound circuit unit 90 is connected with a speaker 91, a receiver 93 and a telephone transmitter (microphone) 95.

With the present embodiment, pointing unit 70 can generate analog outputs associated with pressing force and pressing position. A liquid crystal display (LCD) is used for display unit 40. A vibration-generating device (vibration motor) and a light-emitting device (LED) are provided for an announcing means in addition to the display unit. An announcement (or indication) that pointing unit 70 has been pressed and the pressing force applied can be made by means of the display unit, the vibrating operation of the vibration motor (rotational speeds, rotational patterns), and the light-emitting operation of the LED (the intensity of light, light-emitting patterns).

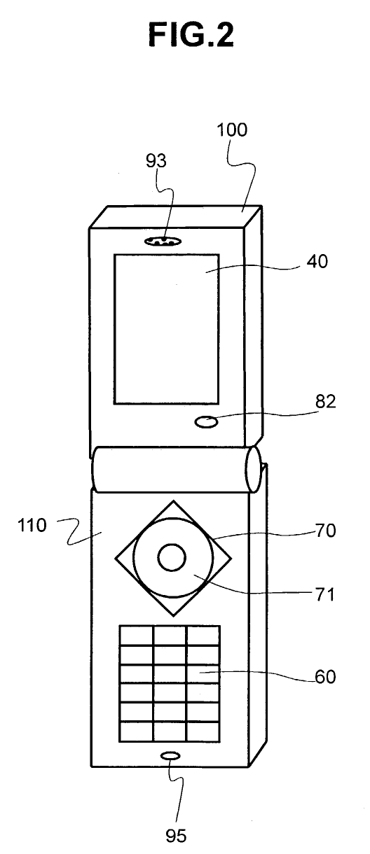

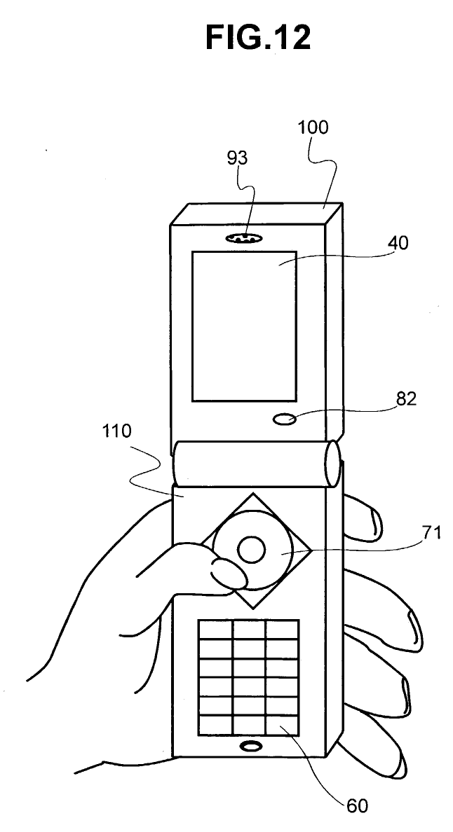

FIG. 2 shows an exemplary external view of a mobile terminal device according to the present embodiment. As shown in FIG. 2, receiver 93, display unit 40 and light-emitting unit 82 are located in an upper case 100, and microphone 95, pointing unit 70 and key entry unit 60 and vibration-generating unit 81 are located in a lower case 110. Vibration-generating unit 81 (not shown in FIG. 2) is located behind the pointing unit and the key entry unit in lower case 110. Pointing unit 70 has a pressing surface 71 on which a user applies a pressing force. Pointing unit 70 is arranged between the hinge connecting the upper and lower cases and the key entry unit when upper case 100 and lower case 110 are open in ready-to-use status. Further, pointing unit 70 is arranged at a position shown in FIG. 12 allowing a user to manipulate the pointing unit with the thumb when the user holds the device by the lower case 110. By arranging vibration-generating unit 81 in lower case 110, vibrations can easily be delivered to the user when the user manipulates the device when holding it by lower case 110.

Further, display unit 40 and light-emitting unit 82 are arranged close to each other to enable a user to confirm light-emitting operations while watching display unit 40.

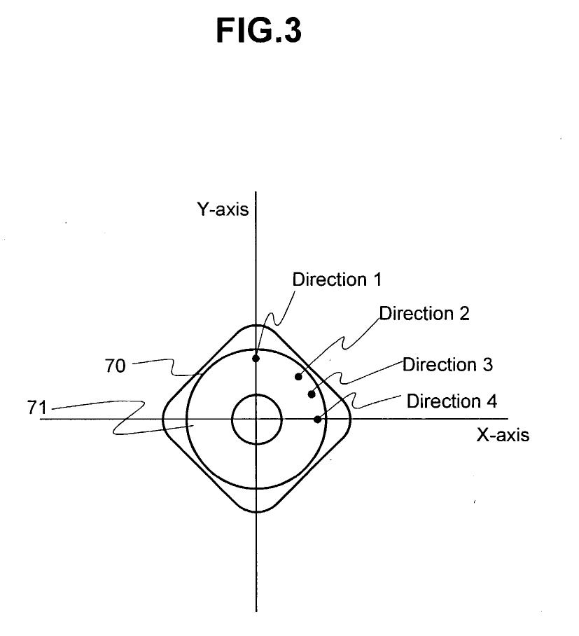

Next, pointing unit 70 is described. As shown in FIG. 3, pointing unit 70 has a circular pressing surface 71, and a diamond-shaped outer frame is mounted at the periphery of pressing surface 71. In the present embodiment, the outer frame is designed as, but is not limited to a diamond shape, and the design may be circular, square, oval or elliptical. A user makes entries using the pressing surface.

A voltage signal is output from pointing unit 70 according to the pressing force on pressing surface 71. The voltage signal consists of two types of components in the X-axis and Y-axis directions on the X-Y coordinate axes shown in FIG. 3, and the output voltage varies to the plus (+) side from the center voltage if the plus (+) side of the relevant axes is pressed, whereas the output voltage varies to the minus (−) side from the center voltage if the minus (−) side is pressed. The variation becomes greater as the pressing force increases. In one embodiment, the center voltage corresponding to an intersection between the X-axis and Y-axis.

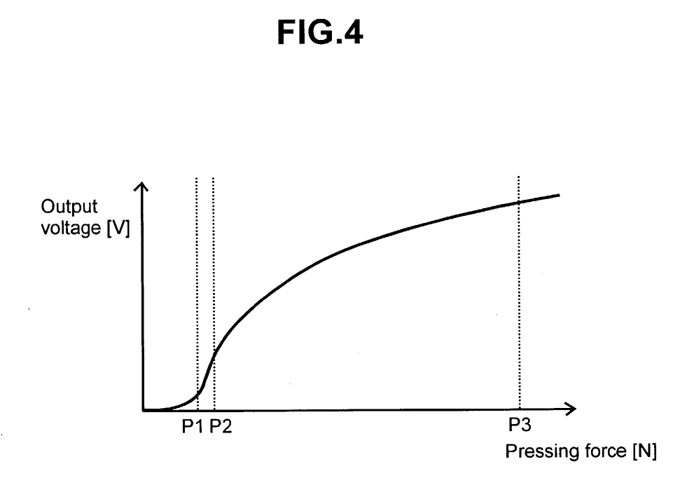

FIG. 4 shows the relationship in the present embodiment between the pressing force of pointing unit 70 and the absolute value of the voltage to be output. As shown in FIG. 4, when the pressing force exceeds the value P1, the absolute value of the output voltage sharply increases; the absolute value of the output voltage increases as the pressing force increases when the pressing force exceeds the value P2; and the voltage starts to saturate at around the value P3 and thereafter. CPU 30 has a function for reading X-axis and Y-axis voltages using AD conversion circuit 31. CPU 30 can identify the pressing force and the pressing position indicated by directions 1 to 4 (see FIG. 3) by vectorizing the voltage signal of the X and Y axes.

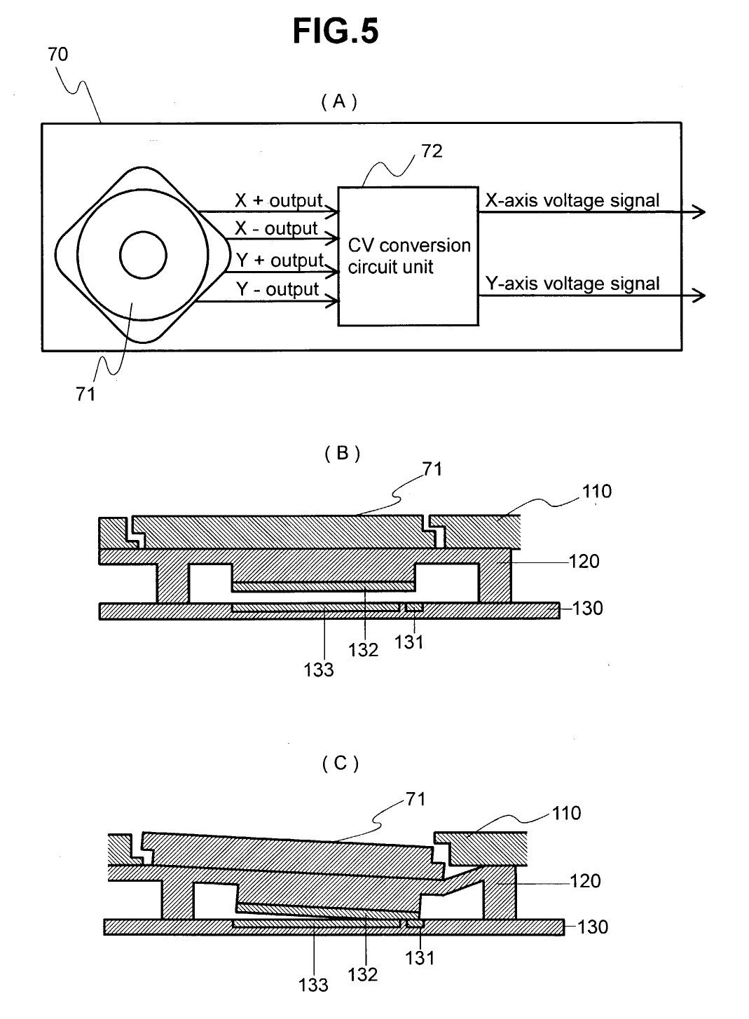

The mechanism for generating a voltage signal from pointing unit 70 according to the present embodiment is described below with reference to FIG. 5. Diagram (A) of FIG. 5 is a block diagram showing pointing unit 70. Diagrams (B) and (C) respectively show section views of the principal part of pointing unit 70 when pressing surface 71 is not pressed and when surface 71 is pressed. Although the pointing unit is divided into an electrostatic capacitance generating unit provided with a pressing surface and a CV conversion circuit unit which converts the electrostatic capacitance generated into a voltage, the description here is for an electrostatic capacitance generating unit, and a description of the CV conversion circuit is omitted because a known CV conversion circuit is employed. It should be noted, however, that the present invention is not limited to a mechanism for generating a voltage signal from pointing unit 70; the mechanism may be for other systems.

The electrostatic capacitance generating unit includes pressing surface 71, the lower case 110, a key button 120, a substrate 130, a ground electrode 131, a carbon surface 132 printed on key button 120, and a substrate pattern surface 133. When no pressing force is entered on pressing surface 71, carbon surface 132 and substrate pattern surface 133, which jointly build capacitance, are positioned apart from each other; thus no electrostatic capacitance is built because no potential difference is generated between them. When a pressing force is entered on pressing surface 71, key button 120 bends to cause carbon surface 132 to contact ground electrode 131 on the substrate, thereby fixing the potential on the carbon surface on the ground terminal. According to the above-described procedures, electrostatic capacitance is generated between the carbon surface and the substrate pattern surface. When a stronger pressing force is applied on pressing surface 71, key button 120 bends further to make the distance between the carbon surface and the substrate pattern smaller, thereby producing a greater electrostatic capacitance. The electrostatic capacitance thus generated at the electrostatic capacitance generating unit is then turned into four different outputs of plus (+) and minus (−) of the X-axis, and plus (+) and (−) of the Y-axis depending on the pressing positions. Such outputs are entered into the CV conversion circuit unit, and the respective difference of the (+) and the (−) capacitance of the X-axis and the Y-axis is output in the form of a voltage signal.

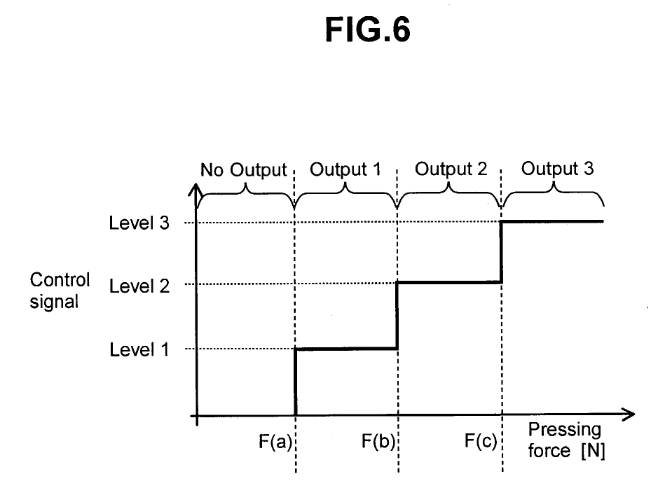

From pointing unit 70, an output voltage shown in FIG. 4 is obtained according to the pressing force on pressing surface 71. The amount of mechanical displacement on pressing unit 71, as well as the output voltage thereof, continuously changes depending on the pressing force. Consequently, a user who manipulates the pressing unit cannot acknowledge how the pressing force is detected since the user does not feel a so-called “clicking feel.” Further, because the output voltage also changes continuously, it is difficult to acknowledge changes in the output of the announcing means if the announcing means is controlled directly by the output. Therefore, in the present embodiment, as shown in FIG. 6, a control signal to control the announcing means is formed by dividing the estimated applied pressing force in a three-step CPU 30 operation by providing threshold values of F(a), F(b) and F(c) to CPU 30, that is, by dividing the output into the steps of output 0 (or no output), output 1, output 2 and output 3, thereby performing step-by-step announcement processing using these control signals. The relationship between the threshold values of F(a), F(b) and F(c) within CPU 30 and threshold values of P1, P2 and P3 within pointing unit 70 in the present embodiment is defined as P1<P2<F(a)<F(b)<F(c)<P3. In the present embodiment, an announcement control program corresponding to the levels of the control signal is stored in memory 50 according to the announcing means, and when a pressing force is applied and the level of a control signal is identified, a program corresponding to the control signal level is read out for delivery to the announcing means. It should be noted, however, the description given here relates to a case where the pressing force is divided into three steps or levels, but the present embodiment is not limited to the number of steps stated above. That is, two pressure levels or four or more pressure levels may be used according to a particular application. In addition, the threshold values are not limited to the fixed values, a user may select or input threshold values.

With the present embodiment, it is possible to set display unit 40, vibration-generating unit 81, light-emitting unit 82 and speaker 91 as the announcing means. Of the announcing methods which can substitute for the “clicking feel”, three methods such as one which uses the visual sense (images or light), one which uses the tactile sense (vibrations) and one which uses the acoustic sense (sounds) are considered practical. In the present embodiment, the method using the visual sense is an announcement using a display on display unit 40 or using the emission of light at light-emitting unit 82; the method using the tactile sense, is an announcement using vibrations at vibration-generating unit 81; and the method using the acoustic sense, is an announcement using sound at speaker 91. A user may choose any one of the announcement methods, or a user may choose a plurality of announcement methods and these methods may be combined.

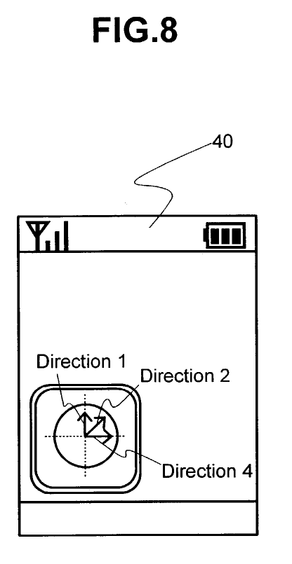

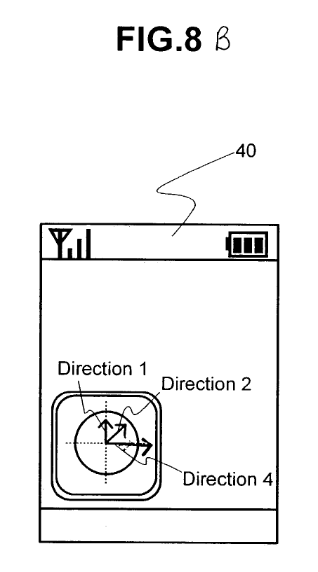

First, an announcing operation where display unit 40 serves as the announcing means is described. Subsequently, other announcing operations where vibration-generating unit 81 is the announcing means will be described. When a pressing force is applied to pressing surface 71 of pointing unit 70, an electric signal associated with the pressing force and the pressing position is output. CPU 30 receives the output from pointing unit 70 in the form of data processed by AD conversion circuit unit 31, and determines that pointing unit 70 has been pressed. CPU 30 displays an image, shown in FIG. 8, based on the output from AD conversion circuit 31 and the control program, stored in memory 50, for display unit 40.

In this image, the length of an arrow indicates the pressing force on pressing surface 71, and the length will vary in steps corresponding to the control signal level when the pressing force varies. Further, the direction of an arrow shows a pressing position. For example, when a position marked “Direction 1” in FIG. 3 is pressed, an arrow marked “Direction 1” in FIG. 8 will be displayed, and when a position marked with “Direction 2” in FIG. 3 is pressed, an arrow marked “Direction 2” in FIG. 8 will be displayed. Likewise, when a position marked “Direction 4” in FIG. 3 is pressed, an arrow marked “Direction 4” in FIG. 8 will be displayed. A change in the pressing force or the pressing position will result in a change in the direction or length of an arrow in FIG. 8, thus announcing the pressing position and the pressing force to a user. FIG. 8B depicts a situation where the position marked “Direction 4” has been pressed with a greater force than other position. Accordingly, the arrow marked “Direction 4” is longer than other arrows.

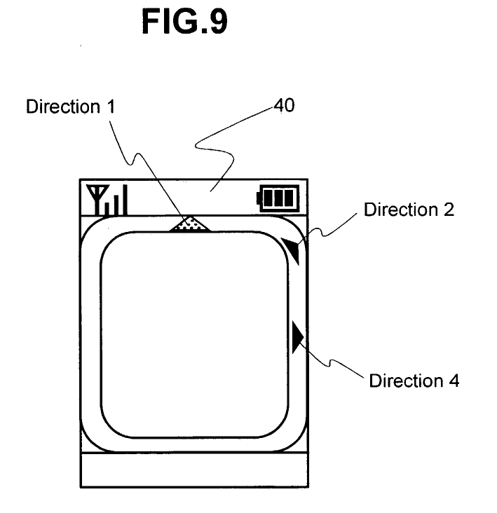

FIG. 9 shows another example of a display screen. The example is arranged such that a direction display area is provided within the display screen, and arrowheads are displayed that correspond to pressing directions. Pressing on a position marked “Direction 1” in FIG. 3 will display an arrowhead for Direction 1 in FIG. 9, and pressing on a position marked “Direction 2” in FIG. 3 will display an arrowhead for Direction 2 in FIG. 9. Likewise, pressing on a position marked “Direction 4” in FIG. 3 will display an arrowhead for Direction 4 in FIG. 9. A change in pressing position or pressing force will result in a change in the direction, the color or the strength of color of an arrowhead in FIG. 9 corresponding to such position or force, thus announcing the pressing position and the pressing force to a user. For example, referring to FIGS. 6 and 8, Direction 1 shows a case where the control signal is in level 1; Direction 2 shows a case of level 2; and Direction 4 shows a case of level 3.

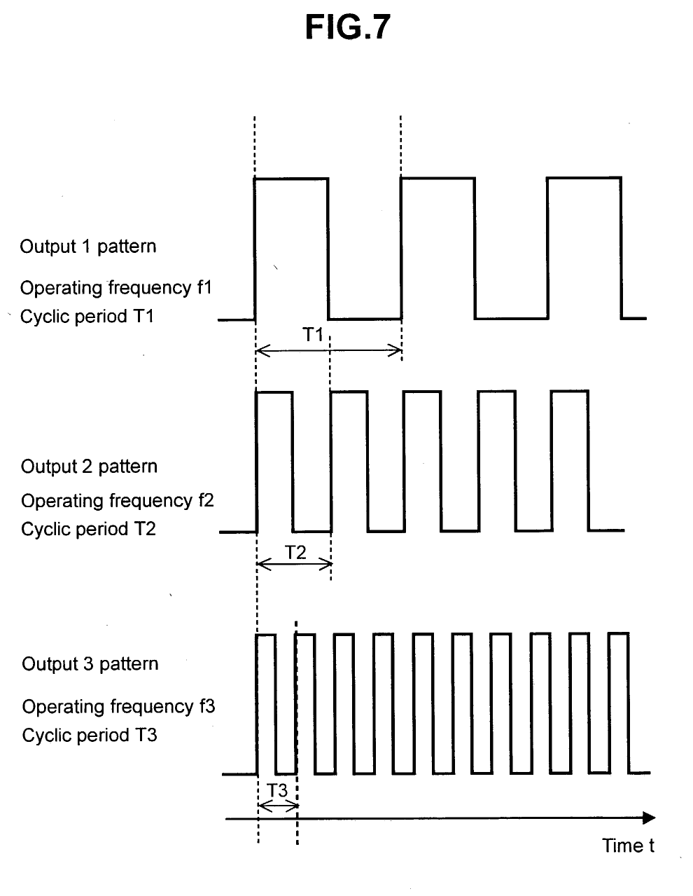

Next, an announcing operation where vibration-generating unit 81 serves as the announcing means or device is described. The announcing means may also be referred to as an “indicator” or “announcer.” In the present embodiment, a motor is incorporated in vibration-generating unit 81 as a vibration source, and when pointing unit 70 is pressed, CPU 30 converts the pressing force to a control signal shown in FIG. 6, reads a control program from memory 50 corresponding to the level of the control signal, and controls driving circuit unit 80. Driving circuit unit 80 drives the vibration-generating unit based on the control information received from CPU 30 to generate vibrations. The voltage delivered to vibration-generating unit 81 from driving circuit unit 80 exhibits the patterns shown in FIG. 7, wherein the activation or the inactivation of vibrations is repeated, causing vibrations to be activated at higher voltages and inactivated at lower voltages. The cyclic period changes in steps according to the pressing force. For example, the cyclic period of intermittence of vibrations when the pressing force is weak and the control signal is in level 1 is expressed as T1 and the intermittence of vibrations is repeated with a longer interval, whereas when the control signal level is increased to 2, the cyclic period of intermittence of vibrations as expressed by T2 will be repeated with a shorter interval. When the pressing force becomes stronger and the control signal level reaches 3, the repetition of intermittence of vibrations becomes much shorter as expressed by T3. In this way, the strength of pressure on pressing surface 71 of pointing unit 70 is converted into vibration patterns and announced to a user.

In the above, an example of announcement to a user has been described wherein the strength of pressure on pressing surface 71 of pointing unit 70 is converted into a frequency repeating the intermittence of vibrations at vibration-generating unit 81. However, announcement may be made to the user by changing the strength of vibrations or changing the vibration frequency (or the rotational speed for a motor) at vibration-generating unit 81 according to the strength of pressure on pressing surface 71. An example where vibration frequency at vibration-generating unit 81 changes is described in the following section.

At vibration-generating unit 80, vibrations are generated by driving vibration-generating unit 81 according to control information output from CPU 30. By arranging for the voltage to be controlled so that, at level 3 of the control signal shown in FIG. 6, where the pressing force is sufficiently strong, vibration-generating unit 81 will vibrate at the rated frequency; vibration-generating unit 81 will vibrate at 60% of the rated vibration frequency at level 2, and vibration-generating unit 81 will vibrate at 30% of the rated vibration frequency at level 3 accordingly, a user can feel the change in the pressing force in the form of a change in vibration frequency.

In the present embodiment, a motor (where an unbalanced weight is installed on the rotation shaft) is employed as a vibration source. However, the present embodiment is not limited to the use of a motor; a speaker which generates low frequencies to be used as vibrations may be used, or otherwise, an apparatus which generates vibrations by intermittently exciting an electromagnet may be used.

Next, an announcing operation where light-emitting unit 82 serves as the announcing means is described. A light emitting element such as a light-emitting diode (hereinafter referred to as “LED”) is built into light-emitting unit 82.Driving circuit unit 80 controls the LED current in steps based on control information from CPU 30, and the LED emits light at the maximum luminance at level 3 of the control signal shown in FIG. 6 where the pressing force is sufficiently strong. By controlling the current so that the LED will emit light at 60% of the maximum luminance at level 2, and will emit light at 30% of the maximum luminance at level 1, a user can acknowledge the announcement of pressing force by means of the emission of the LED, and can also acknowledge changes in the pressing force by means of the difference in the luminance of the LED.

Driving circuit unit 80 also has a function to control the LED voltage in the form of the patterns shown in FIG. 7, and therefore, announcement of the pressing force at pointing unit 70 is also possible by means of the emission patterns of the LED.

In an area where the AC line frequency is 50 Hz, the frequency of an AC voltage applied to a fluorescent light is 50 Hz, and it is difficult to identify the emission pattern with the human eye. It is widely known that the human eyes can identify emission patterns only in the frequency of 30 Hz or lower. Therefore, it is necessary that emission patterns of the LED be created at a frequency of 30 Hz or lower. In a mobile terminal device according to the present embodiment, at level 1 where the pressing force is weak, a frequency of 10 Hz is used for the emission pattern, 20 Hz for level 2, and 30 Hz for level 3, thus enabling even human eyes to clearly confirm the difference in the emission patterns.

Now, an announcing operation where speaker 91 serves for announcing measures is described. The announcement of pressing force is executed by using sound. When pointing unit 70 is pressed, sound data which has been converted to a control signal level corresponding to the pressing force and also corresponding to the signal level is read memory 50 by CPU 30, and the data is output to sound circuit unit 90. sound circuit unit 90 enables speaker 91 to reproduce sounds which have different tone quality or sounds that have different pitches depending on different pressing forces. Thus, through the difference in sounds, a user can acknowledge the fact that pointing unit 70 has been pressed, as well as changes in the pressing force.

Further, sound circuit unit 90 has a function to control the reproduction sound volume based on the data from CPU 30 corresponding to the pressing force, thereby enabling changes in the sound volume according to the level of the pressing force. When the control signal is in level 3, sound circuit unit 90 generates maximum sound volume. As the pressing force reduces, a user can acknowledge changes in the pressing force of the pointing operation by the changes in sound volume. A user can set the control signal at 60% of the maximum sound volume for level 2, and 30% of the maximum sound volume for level 1. When the device is used in an area where generating a sound would be unfavorable or prohibited, the announcement can also be made using receiver 93.

A sound to be generated through the speaker 91 may be an electronic bell sound, a beep, a chime, a bell, the sound of a musical instrument, the sound of water dripping, or a melody. These sounds may be permanent data that are stored in memory 50 as sound data at the time a mobile terminal device is manufactured, or they may be such that a user can freely set them, for example, sound data or memory data downloaded to memory 50 by a user via the Internet after the user purchases a mobile terminal device, or they may be sound data or melody data that are created and stored in memory 50 by a user using a personal computer, etc., after the purchase of a mobile terminal device.

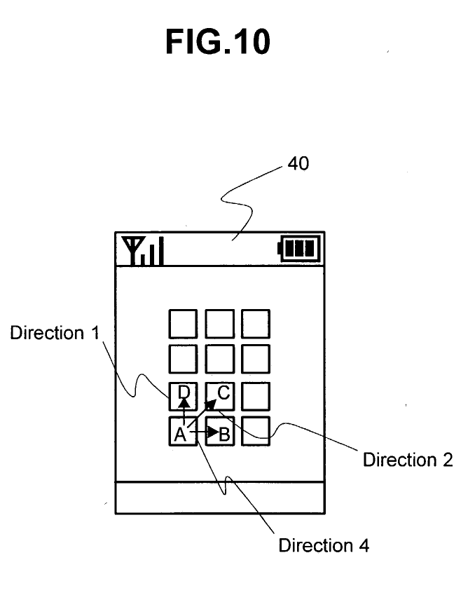

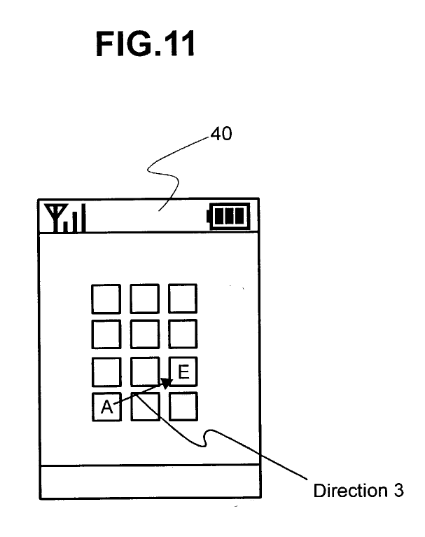

With a mobile terminal device according to the present embodiment, the moving directions of the pointer are not limited to vertical and horizontal directions (up, down, right and left directions); the pointer can be directly moved to oblique directions. Consequently, assuming a menu screen, etc. shown in FIG. 10, when Direction 1 in FIG. 3 is pressed, the pointer moves vertically (in this case, up), thus allowing the menu to move to menu D from menu A. Further, when Direction 4 in FIG. 3 is pressed, the pointer moves horizontally (to the right in this case), thus allowing the menu to move to menu B from menu A. Furthermore, when Direction 2 in FIG. 3 is pressed, the pointer moves obliquely, thus allowing the menu to move directly from menu A to menu C, which is located in a position diagonal to the menu A. In addition, pressing Direction 3 in FIG. 3 enables the pointer to move similarly to a knight in chess as shown in FIG. 11, that is, the pointer can be moved from one grid to another gird which is located at a position that can be reached by first moving the pointer horizontally two grids (either right or left) or vertically (either up or down), and then by moving the pointer one grid in the direction orthogonal to the moving direction of the first movement, thus allowing a direct movement to menu E from menu A. It should be noted that, in the present embodiment, the movement of pointer as described above applies to selecting a menu; however, the present embodiment is not limited to such application, but it may be applied for actions of characters of a game, etc. The pointer can be moved at a variety of speeds based on pressing power. CPU30 has one or more threshold values for changing speeds. The threshold values are not limited to the fixed values, and a user can select or input threshold values.

Referring to the setting of the means for announcing the pressure on the pointing device, setting any one of the announcing means enables the announcing means only, thus saving power at the time of issuing an announcement. When a plurality of settings is made, it is possible to acknowledge that pressure has been detected using more than one sense (at least two senses from the choices of visual sense, acoustic sense and tactile sense), thus ensuring a reliable announcement.

As described above, the present embodiment, describes a manipulation announcing device employed for a mobile terminal device. However, the present invention is not limited to a mobile terminal device, but may be applied to any other electronic apparatus having a pointing device.

According to the present invention, in a manipulation announcing device which incorporates a pointing device capable of delivering outputs associated with a pressing position and a pressing force, it is possible to announce the fact that a pointing unit has been pressed through an indication on a display, a vibrating operation (i.e., levels and patterns) with vibration-generating means, a light emitting operation with a light-emitting means such as an LED (i.e., intensity of light and emission patterns), and a sound-generating operation with a speaker.

What is claimed is:

1. A mobile terminal device, comprising:
a pointing unit which generates outputs associated with a pressing position and a pressing force on a pressing surface;
a control unit which controls various functions according to the outputs of the pointing unit;
a display unit which is controlled by the control unit; and
an announcing device configured to provide a first announcement corresponding to a first pressure force applied to the point unit and a second announcement corresponding to a second pressure force applied to the point unit, the first and second announcements being different from each other.

2. The mobile terminal device as claimed in claim 1, wherein the control unit has a plurality of threshold values of pressing force for controlling the announcing device.

3. The mobile terminal device as claimed in claim 1, wherein the announcing device enables the pressing force exerted on the pointing unit to be indicated on the display unit.

4. The mobile terminal device as claimed in claim 1, wherein the announcing device includes a vibration-generating unit, the pressing force exerted on the pointing unit being announced by the operation of the vibration-generating unit when the pressing force exerted on the pointing unit is detected.

5. The mobile terminal device as claimed in claim 1, wherein the announcing device includes a light-emitting unit, the pressing force exerted on the pointing unit being announced by the light-emitting action of the light-emitting unit when the pressing force exerted on the pointing unit is detected.

6. The mobile terminal device as claimed in claim 1, wherein the announcing device includes a sound-generating unit, the pressing force exerted on the pointing unit being announced by generating a sound at the sound-generating unit when the pressing force exerted on the pointing unit is detected.

7. The device of claim 1, wherein the control unit controls the announcing device to provide the first announcement or second announcement according to the pressing force applied to the pointing unit.

8. A portable electronic device, comprising:
an input device configured to output information according to an input provided to the input device, the outputted information including position information and pressure information; and
a controller configured to perform functions according to the outputted information.

9. The device of claim 8, further comprising:
a display unit which is controlled by the controller; and
an indicator configured to provide a first indication if a first pressure force is applied to the input device and a second indication if a second pressure force is applied to the input device, the first and second forces being different from each other and the first and second indications being different from each other.

10. The device of claim 9, wherein the controller controls outputs of the indicator based on information outputted by the input device.

11. The device of claim 8, wherein the indicator includes a vibration-generating unit, and the controller controls an operating state of the vibration-generating unit based on the pressure information outputted by the input device.

12. The device of claim 11, wherein the operating state is a vibration pattern of the vibration-generating unit.

13. The device of claim 11, wherein the operating state is a vibration frequency of the vibration-generating unit.

14. The device of claim 8, wherein the indicator includes a light-emitting unit, and the controller controls an operating state of the light-emitting unit based on pressing force exerted on the input device.

15. The device of claim 14, wherein the operating state is an intensity of light, a frequency of light, or a light-emitting pattern.

16. The device of claim 8, wherein the device is a mobile phone, a personal digital assistant, a gaming device, a position locator, a video player, or an audio player.

17. A portable device, comprising:
a processor to process data;
a display area to display data processed by the processor; and
a pointer configured to output a first signal if a first pressing force is exerted on the pointer and a second signal if a second pressing force is exerted on the pointer.

18. The device of claim 17, wherein the pointer is configured to provide a third signal if a first portion of the pointer is pressed and a fourth signal if a second portion of the pointer is pressed, the first signal being different from the second signal, the third signal being different from the fourth signal.

19. The device of claim 17, further comprising:
an electrostatic capacitance generator coupled to the pointed to detect a pressing force exerted on the pointer.

20. The device of claim 19, wherein the capacitor generator includes:
a pressing surface;
a first electrode provided below the pressing surface;
a second electrode provide on a substrate that is placed below the first electrode, the second electrode being spaced apart from the first electrode by a given distance; and
a ground electrode adjacent to the second electrode.

21. A mobile terminal device, comprising:
a pointing unit which generates outputs associated with a pressing position and a pressing force on a pressing surface;
a control unit which controls various functions by using the outputs coming from the pointing unit;
a display unit which is controlled by the control unit; and
a light-emitting unit which announces, by means of light, the fact that the pressing force exerted on the pointing unit has been detected by the control unit;
wherein the light-emitting unit is located in the vicinity of the display unit.
